(19) United States
(12) Patent Application Publication
(10) Pub. No.: US 2008/0134261 A1
(43) Pub. Date: Jun. 5, 2008

(54) Viewing information distribution system, television reception apparatus, and information processing apparatus

(75) Inventors: Hirono Tsubota, Osaka (JP); Yasuo Masaki, Osaka (JP); Akinori Okazaki, Osaka (JP); Masao Kokado, Osaka (JP); Sadanori Murakami, Osaka (JP); Guokun Zuo, Osaka (JP); Masahiro Takeshita, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/953,631

(22) Filed: Dec. 10, 2007

(30) Foreign Application Priority Data
Dec. 1, 2006 (JP) 2006-325771 (P)

(51) Int. Cl. H04N 7/173

(52) U.S. Cl. 725/106

(57) ABSTRACT

A system allowing a viewer of a program to know a rating is provided. A viewing information distribution system includes an IP telephone management server and each television connected to the Internet. The television is controlled by a signal emitted from a remote control terminal having an IP telephone function. The IP telephone management server includes a processor carrying out operational processing and communication control and a database. The IP telephone management server and the television communicate with each other in accordance with a session initiation protocol. The television transmits a selected channel to the IP telephone management server. The IP telephone management server summarizes viewing information received from each television and distributes the information to each television. Receiving statistic data, the television displays that figure in a video image display area.

### BACKGROUND OF THE INVENTION

1. Field of the Invention

The present invention relates to a technique to calculate a rating of a video image, and particularly to a technique to calculate a rating in a television receiving apparatus connected to a communication line.

2. Description of the Background Art

A rating in a television receiving apparatus is calculated by using specific equipment. Here, it is a provider providing rating calculation service or a broadcast station broadcasting a program that can first obtain the calculated result.

With regard to calculation of the rating, for example, Japanese Patent Laying-Open No. 2002-324025 discloses a technique to conduct a survey of effective rating in Internet broadcasting.

In addition, Japanese Patent Laying-Open No. 2003-153105 discloses a technique to allow automatic viewing of a program with a high rating or an emergency news program.

Moreover, Japanese Patent Laying-Open No. 2004-128795 discloses a technique to facilitate determination of viewing or recording of a program.

Further, Japanese Patent Laying-Open No. 2006-041587 discloses a technique to reduce efforts in selecting a program.

In addition, Japanese Patent Laying-Open No. 2004-015087 discloses a system allowing information exchange among viewers.

According to the technique disclosed in each publication above, in some cases, a viewer has not been able to readily obtain a rating of a program.

The present invention was made to solve the above-described problems, and an object of the present invention is to provide a viewing information distribution system allowing a viewer to readily obtain a rating.

Another object is to provide a viewing information distribution system allowing a rating for each attribute of a viewer to be obtained.

Another object is to provide a television reception apparatus allowing a viewer to readily obtain a rating.

Yet another object is to provide a television reception apparatus allowing a rating for each attribute of a viewer to be obtained.

### SUMMARY OF THE INVENTION

In summary, in order to solve the above-described problems, a viewing information distribution system according to one aspect of the present invention includes a plurality of television reception apparatuses and an information processing apparatus connected to the plurality of television reception apparatuses via a communication line. Each television reception apparatus includes a communication unit configured to transmit or receive a signal to or from the information processing apparatus via the communication line in accordance with a communication protocol defined in advance, an input unit configured to accept an instruction to select any channel from among a plurality of channels, a selection unit configured to select any channel based on the instruction, a storage unit configured to store position data of each of the television reception apparatus and the information processing apparatus in the communication line, and a transmission control unit configured to control the communication unit based on the position data of the information processing apparatus so that the position data of the television reception apparatus and channel data for identifying a channel selected by the selection unit are transmitted to the information processing apparatus. The information processing apparatus includes a communication unit configured to transmit or receive a signal to or from each of the plurality of television reception apparatuses in accordance with the communication protocol defined in advance, an obtaining unit configured to obtain the position data and the channel data from each piece of viewing information received from each television reception apparatus, a storage unit configured to store the obtained position data and channel data, a calculation unit configured to calculate each rating of each channel based on the channel data, and a distribution control unit configured to control the communication unit so that the calculated rating is distributed to each television reception apparatus for each channel selected in each television reception apparatus, based on each piece of position data. Each television reception apparatus includes an obtaining unit configured to obtain the rating from a signal received from the information processing apparatus and a display unit configured to display the rating obtained by the obtaining unit.

According to another aspect of the present invention, a television reception apparatus capable of communicating with an information processing apparatus connected to a communication line is provided. The information processing apparatus communicates with each of a plurality of the television reception apparatuses in accordance with a communication protocol defined in advance. The television reception apparatus includes: a communication unit configured to transmit or receive a signal to or from the information processing apparatus via the communication line in accordance with the communication protocol defined in advance; an input unit configured to accept an instruction to select any channel from among a plurality of channels; a selection unit configured to select any channel based on the instruction; a storage unit configured to store position data of each of the television reception apparatus and the information processing apparatus in the communication line; and a transmission control unit configured to control the communication unit based on the position data of the information processing apparatus so that the position data of the television reception apparatus and channel data for identifying a channel selected by the selection unit are transmitted to the information processing apparatus. The information processing apparatus obtains the position data and the channel data from the viewing information received from the plurality of television reception apparatuses, stores the obtained position data and channel data, calculates each rating of each channel based on the channel data, and distributes the calculated rating to each television reception apparatus for each channel selected in the television reception apparatus, based on the position data. The television reception apparatus includes an obtaining unit configured to obtain the rating from a signal received from the information processing apparatus and a display unit configured to display the rating obtained by the obtaining unit.

According to yet another aspect of the present invention, an information processing apparatus communicating with a plurality of television reception apparatuses connected to a communication line is provided. Each television reception apparatus transmits to the information processing apparatus, position data representing a position of the television reception apparatus in the communication line and channel data for identifying a selected channel in accordance with a communication protocol defined in advance. The information processing apparatus includes: a communication unit configured to transmit or receive a signal to or from each of the plurality of television reception apparatuses in accordance with the communication protocol defined in advance; a storage unit configured to store the position data and the channel data received from each television reception apparatus; a calculation unit configured to calculate each rating of each channel based on the channel data; and a distribution control unit configured to control the communication unit so that the calculated rating is distributed to each television reception apparatus for each channel selected in each television reception apparatus, based on each piece of position data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a configuration of a viewing information distribution system 10 according to a first embodiment of the present invention.

FIG. 2 is a sequence chart illustrating processing performed between an IP telephone management server 20 and a television 40.

FIG. 3 is a block diagram showing a configuration of a function implemented by television 40.

FIG. 4 is a block diagram showing a hardware configuration of television 40.

FIG. 5 is a conceptual diagram showing one manner of storage of data in a memory 412 of television 40.

FIG. 6 is a conceptual diagram of a configuration of a frame 600 used in communication between television 40 and IP telephone management server 20.

FIG. 7 is a flowchart showing a main part of a series of operations performed by a CPU 410 of television 40.

FIG. 8 is a block diagram showing a function implemented by IP telephone management server 20.

FIG. 9 is a block diagram showing a hardware configuration of a computer system 900 that attains a function as IP telephone management server 20.

FIG. 10 is a conceptual diagram showing one manner of storage of data in a hard disk 950 of computer system 900.

FIG. 11 is a conceptual diagram showing a configuration of a frame 1100 transmitted from IP telephone management server 20 to each television 40.

FIG. 12 is a flowchart showing a part of processing performed by a CPU 910 of IP telephone management server 20.

FIG. 13 illustrates one manner of storage of data in memory 412 of a television according to a variation of the embodiment of the present invention.

FIG. 14 is a block diagram showing a configuration of a function implemented by an IP telephone management server 1400.

FIG. 15 is a block diagram showing a configuration of a function implemented by a television 1500.

FIG. 16 is a block diagram showing a configuration of a main function of a remote control terminal 50.

FIG. 17 shows appearance of remote control terminal 50.

### DESCRIPTION OF THE PREFERRED EMBODIMENTS

An embodiment of the present invention will be described hereinafter with reference to the drawings. In the description below, the same elements have the same reference characters allotted. Their name and function are also identical. Therefore, detailed description thereof will not be repeated.

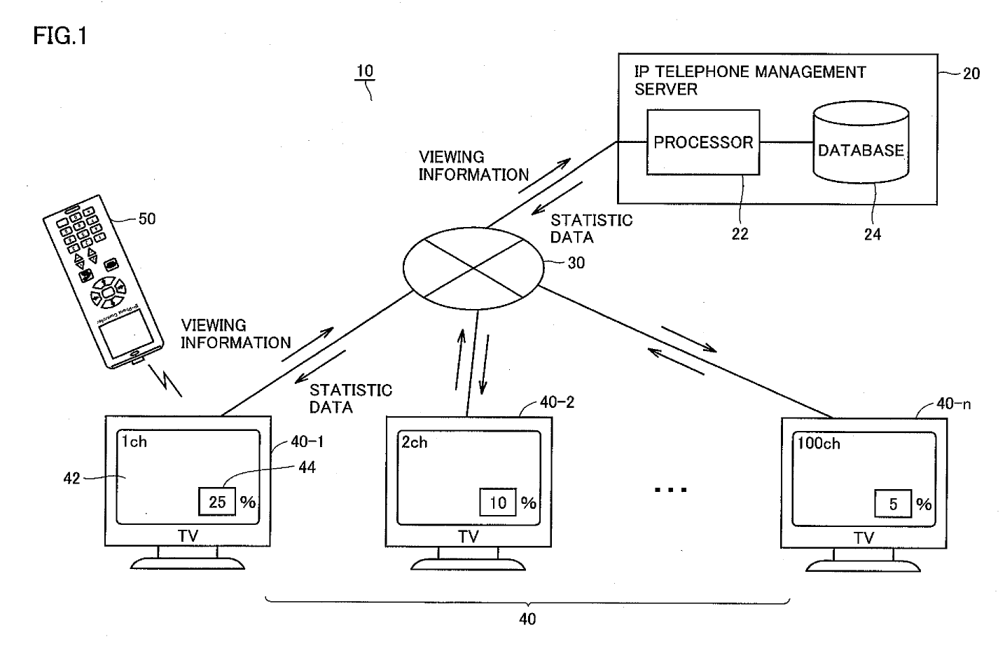

Initially, a manner of use of a viewing information distribution system 10 according to an embodiment of the present invention will be described. FIG. 1 illustrates a configuration of viewing information distribution system 10. Viewing information distribution system 10 includes an IP (Internet Protocol) telephone management server 20 and televisions 40-1, 40-2, 40-n (hereinafter, denoted as television 40 when collectively referred to). IP telephone management server 20 and television 40 are connected to each other through the Internet 30. Television 40 is controlled by a signal emitted from a remote control terminal 50 having an IP telephone function.

IP telephone management server 20 includes a processor 22 carrying out operational processing and communication control and a database 24 storing data input in advance and data generated or obtained by processor 22.

IP telephone management server 20 and television 40 can communicate with each other in accordance with session initiation protocol (SIP). For example, television 40-1 transmits a selected channel (for example, channel “1”) to IP telephone management server 20 as viewing information. IP telephone management server 20 summarizes viewing information (such as channel information, time zone, and the like) received from each television 40 and calculates statistic data. Processor 22 distributes the statistic data to each television 40 through the Internet 30. Receiving the statistic data, television 40-1 displays that figure (for example, 25%) in a video image display area 42 (image 44).

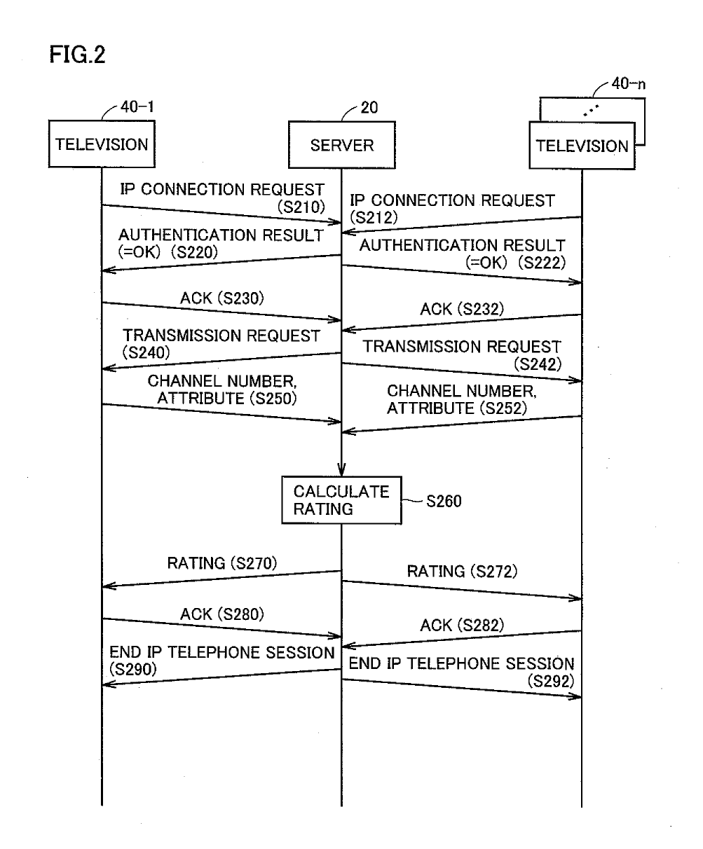

Referring next to FIG. 2, communication between IP telephone management server 20 and each television 40 will be described. FIG. 2 is a sequence chart illustrating processing performed by IP telephone management server 20 and television 40.

In step S210, television 40-1 requests IP (Internet Protocol) connection to IP telephone management server 20. In step S220, IP telephone management server 20 performs authentication processing defined in advance, based on authentication data transmitted from television 40-1, and transmits a signal indicating authentication result “OK”.

In step S230, television 40-1 transmits an acknowledge ACK to IP telephone management server 20. Thus, IP telephone session between television 40-1 and server 20 is established.

In step S240, IP telephone management server 20 transmits to television 40-1, a request to transmit viewing information. Receiving the request, television 40-1 reads prescribed data from a contained memory and generates data for transmission to IP telephone management server 20. In step S250, television 40-1 transmits a signal containing a channel number and an attribute of television 40-1 to IP telephone management server 20.

Processing for establishing IP telephone session (steps S212 to S232) and processing for transmitting viewing information (steps S242 and S252) are performed, also between another television 40-n and IP telephone management server 20.

When IP telephone management server 20 obtains viewing information from each television 40 within a time period set in advance, processor 22 calculates a rating for each channel based on the information (step S260).

IP telephone management server 20 transmits the rating for each channel to each television 40, in line with the channel number contained in the viewing information transmitted from each television 40 (steps S270 and S272).

When acknowledge ACIC is transmitted from each television 40 (steps S280 and S282), the IP telephone session between television 40 and IP telephone management server 20 ends (steps S290 and S292).

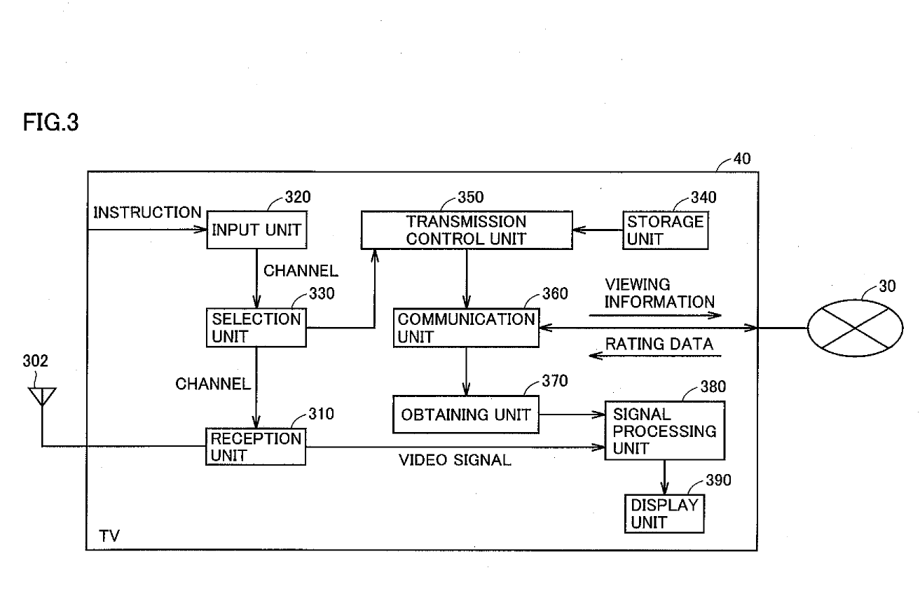

Referring next to FIG. 3, television 40 according to the present embodiment will be described. FIG. 3 is a block diagram showing a configuration of a function implemented by television 40. Television 40 is connected, for example, to an antenna 302. Television 40 includes a reception unit 310, an input unit 320, a selection unit 330, a transmission control unit 350, a storage unit 340, a communication unit 360, an obtaining unit 370, a signal processing unit 380, and a display unit 390.

Reception unit 310 accepts input of a signal received by antenna 302. Input unit 320 accepts input of an instruction to television 40. The instruction includes, for example, an infrared signal emitted from a remote controller (not shown), manipulation of a manipulation panel (not shown) provided in a housing of television 40, and the like. Input unit 320 outputs a signal in accordance with these instructions to selection unit 330. For example, input unit 320 accepts input of an instruction to select a channel for receiving TV broadcast waves.

Selection unit 330 is connected to input unit 320 so as to operate based on an output from input unit 320. For example, selection unit 330 switches between channels as selected by reception unit 310 based on a channel number. The channel number selected by selection unit 330 is sent to transmission control unit 350.

Storage unit 340 stores attributes of television 40 and data (such as IP address) for specifying a position of television 40 and IP telephone management server 20 when communication via IP telephone is established between television 40 and IP telephone management server 20. Details of a data structure in storage unit 340 will be described later.

Transmission control unit 350 controls communication by communication unit 360 based on data output from selection unit 330 and data stored in storage unit 340. For example, transmission control unit 350 causes communication unit 360 to perform prescribed communication processing using an IP address of IP telephone management server 20, so that position data representing a position of television 40 in a network and a number for identifying a channel selected by selection unit 330 are transmitted to IP telephone management server 20.

Communication unit 360 transmits or receives a signal to or from IP telephone management server 20 via a communication line in accordance with a communication protocol defined in advance. The communication protocol defined in advance is, for example, Internet protocol.

Obtaining unit 370 is connected to communication unit 360 so as to operate based on an output from communication unit 360. Obtaining unit 370 obtains rating data of a channel selected by selection unit 330, based on a transmission signal from IP telephone management server 20 received by communication unit 360.

Signal processing unit 380 is connected to reception unit 310 and obtaining unit 370 so as to operate based on each output from reception unit 310 or obtaining unit 370. For example, signal processing unit 380 subjects a video signal output from reception unit 310 to signal processing defined in advance and sends the resultant signal to display unit 390. In addition, signal processing unit 380 generates an image signal for displaying a rating based on the rating data obtained by obtaining unit 370 and sends the generated signal to display unit 390.

Display unit 390 is connected to signal processing unit 380 so as to operate based on an output from signal processing unit 380. Display unit 390 displays a video image broadcast on television based on the video signal.

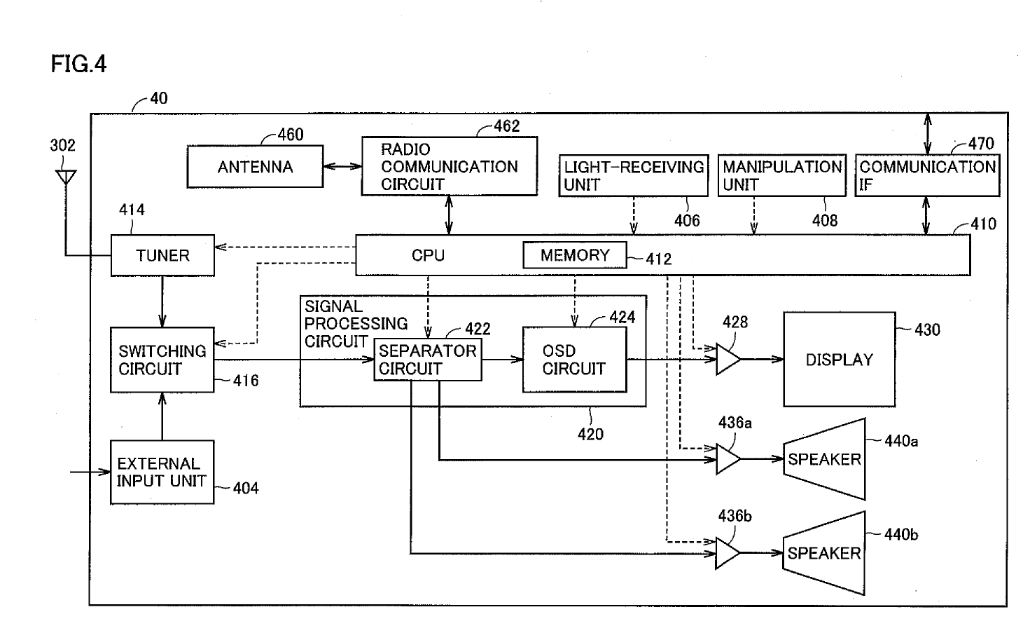

Referring next to FIG. 4, a specific configuration of television 40 according to the present embodiment will be described. FIG. 4 is a block diagram showing a hardware configuration of television 40. Television 40 includes an external input unit 404, a light-receiving unit 406, a manipulation unit 408, a communication I/F (Interface) 470, a CPU 410, a tuner 414, a switching circuit 416, a signal processing circuit 420, a display driver 428, a display 430, amplifiers 436a and 436b, and speakers 440a and 440b. CPU 410 includes a memory 412. Signal processing circuit 420 includes a separator circuit 422 and an OSD (On Screen Display) image generation circuit 424.

External input unit 404 accepts input of a video audio signal to television 40.

Switching circuit 416 switches an input source of a signal sent to signal processing circuit 420 by selecting between an output from external input 404 and an output from tuner 414.

Light-receiving unit 406 receives a control signal (such as an infrared signal) for operating television 40. The signal is emitted, for example, by a remote control device (not shown). Light-receiving unit 406 converts the control signal to an electric signal and sends the resultant signal to CPU 410.

Manipulation unit 408 accepts a manipulation instruction to television 40. Manipulation unit 408 is implemented, for example, as a power switch or other buttons provided on the front face of the housing of television 40.

CPU 410 controls an operation of television 40 based on data stored in memory 412. For example, CPU 410 executes a command included in a signal output from light-receiving unit 406, manipulation unit 408 or communication I/F 470. More specifically, in response to an input of a command to select a channel, CPU 410 sends a switching signal to tuner 414 to select the channel specified by that command. Tuner 414 switches the channel in accordance with the signal, and a signal in accordance with the broadcast wave received in the tuned channel is sent to switching circuit 416.

In another aspect, CPU 410 generates data for sending the data stored in memory 412 to a sender of the command, in accordance with a transmission command obtained from an outside source via communication I/F 470. For example, when television 40 receives a request to transmit viewing information from IP telephone management server 20, data including a number representing a channel selected by tuner 414 is generated and transmitted to IP telephone management server 20 in the form of packet data via communication I/F 470.

Signal processing circuit 420 is configured to operate based on an output from switching circuit 416 and an output from CPU 410. Specifically, signal processing circuit 420 subjects the video audio signal output from switching circuit 416 to signal processing defined in advance and sends the resultant signal to display driver 428 or amplifiers 436a and 436b. More specifically, in signal processing circuit 420, separator circuit 422 changes a color tone of the video image displayed on display 430 based on the output from CPU 410, or splits the signal output from switching circuit 416 into a video signal and an audio signal. OSD image generation circuit 424 generates data for displaying a video signal obtained by separator circuit 422 with text information being combined, combines the generated signal with the video signal, and sends the combined signal to display driver 428.

Display driver 428 subjects the image signal output from OSD image generation circuit 424 to processing defined in advance based on the control signal output from CPU 410, and sends the resultant signal to display 430. Display 430 displays the video image based on that signal.

Amplifiers 436a and 436b adjust an output level of an audio signal output from separator circuit 422 based on the control signal from CPU 410 and send the resultant audio signal to speakers 440a and 440b respectively. Speakers 440a and 440b provide audio output based on that signal.

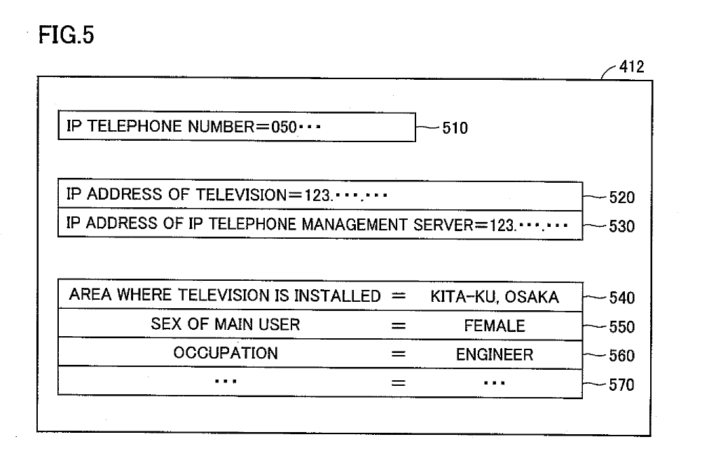

Referring next to FIG. 5, a data structure of television 40 according to the present embodiment will be described. FIG. 5 is a conceptual diagram showing one manner of storage of data in memory 412 of television 40. Memory 412 includes a plurality of areas for storing data.

A telephone number assigned to television 40 in advance for establishing communication via IP telephone provided by IP telephone management server 20 is stored in an area 510. The IP address assigned to television 40 for communication in accordance with the Internet protocol is stored in an area 520. The IP address of IP telephone management server 20 is stored in an area 530.

An attribute of television 40 is stored in areas 540 to 570. For example, data representing an area where television 40 is installed is stored in area 540. The data refers to such data as selected by the user of television 40 from area data prepared in advance by a manufacturer of television 40.

Data representing sex of a main user of television 40 is stored in area 540. The data also refers to data selected from data items prepared in advance. Data representing occupation of the user of television 40 is stored in area 560. Other attributes are also stored in area 570. Each attribute above has been described as being selected by the user from data prepared in advance, however, configuration may be such that the user of television 40 himself/herself inputs the data item.

Here, each piece of data is updated by using a remote control terminal, by manipulating manipulation unit 408, or by providing data to CPU 410 via communication I/F 470.

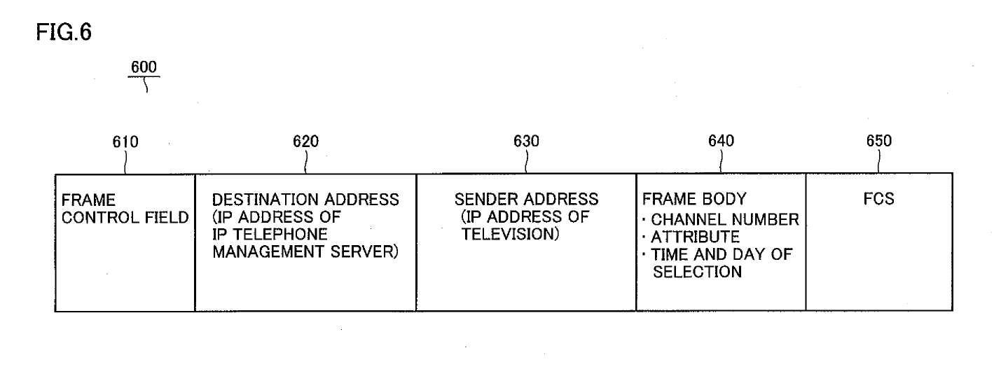

Referring next to FIG. 6, a frame 600 used in communication between television 40 and IP telephone management server 20 will be described. FIG. 6 is a conceptual diagram of a configuration of frame 600.

Frame 600 includes a frame control field 610, a destination address 620, a sender address 630, a frame body 640, and an FCS (Frame Check Sequence) 650. Destination address 620 refers, for example, to an IP address of IP telephone management server 20. Sender address 630 refers, for example, to an IP address assigned to television 40. Frame body 640 includes a channel number selected in television 40, attribute information (FIG. 5) input in advance for television 40, and data of time and day when the channel was selected.

Frame 600 is generated in response to a command to CPU 410. CPU 410 transmits generated frame 600 to IP telephone management server 20 via communication I/F 470.

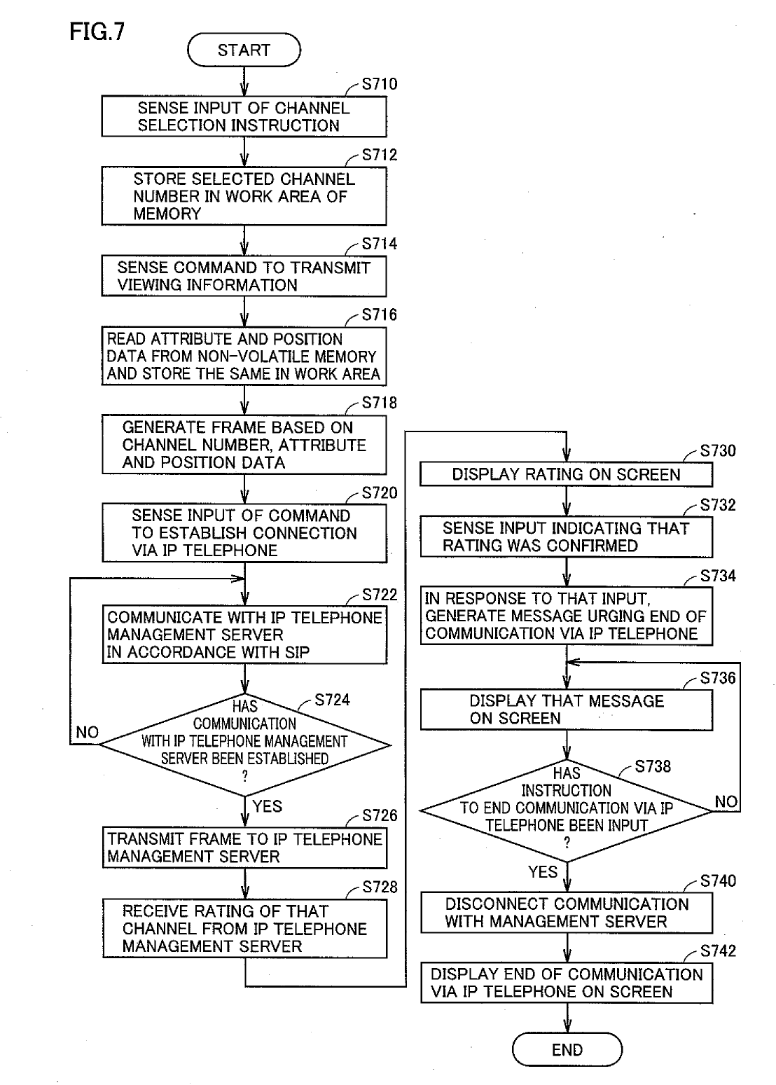

Referring next to FIG. 7, a control structure of television 40 according to the present embodiment will be described. FIG. 7 is a flowchart showing a main part of a series of operations performed by CPU 410. The operation is performed based on a command provided to television 40 or sensing by CPU 410 of timing of execution.

In step S710, CPU 410 senses input of a selection instruction of a channel to be selected by tuner 414, based on a signal output from light-receiving unit 406. Based on the instruction, CPU 410 sends a command to switch a channel to tuner 414. In response to the command, tuner 414 selects the designated channel.

In step S712, CPU 410 stores the selected channel number in a work area of memory 412.

In step S714, CPU 410 senses reception of a command to transmit viewing information based on input through communication I/P 470 or a signal output from light-receiving unit 406.

In step S716, CPU 410 reads the attribute and the position data from a non-volatile area of memory 412 (FIG. 5) and stores the same in a work area. In step S718, CPU 410 generates frame 600 based on the channel number, the attribute, and the position data.

In step S720, CPU 410 senses input of a connection command for establishing communication via IP telephone with IP telephone management server 20. For example, when a message that “Is IP connection to be established?” is displayed on display 430 and when the user of television 40 provides answer “YES” to television 40 by manipulating a remote control terminal (not shown), CPU 410 senses input of the connection command.

In step S722, CPU 410 starts communication with IP telephone management server 20 via communication I/F 470 in accordance with the session initiation protocol.

In step S724, CPU 410 determines whether communication with IP telephone management server 20 has been established or not, based on a signal received via communication I/F 470. When CPU 410 determines that communication with IP telephone management server 20 has been established (YES in step S724), control is switched to step S726. Otherwise (NO in step S724), control returns to step S722.

In step S726, CPU 410 transmits frame 600 (step S718) to IP telephone management server 20 via communication I/F 470. Receiving frame 600, IP telephone management server 20 extracts the channel number from the frame and calculates the rating. Namely, during communication with television 40, IP telephone management server 20 obtains similar signals from other televisions that have established connection with IP telephone management server 20.

When IP telephone management server 20 finishes calculation of the rating, a frame containing the rating is generated and multicast to respective televisions 40 that have established IP connection.

In step S728, CPU 410 senses reception of the rating of a program in a channel selected by tuner 414, based on the signal received via communication I/F 470. CPU 410 obtains the rating from the received frame and writes the data in the area allocated in memory 412.

In step S730, CPU 410 reads the data written in memory 412 and sends the data to OSD image generation circuit 424. OSD image generation circuit 424 generates an image signal for displaying the rating based on that data, and sends the generated signal to display driver 428. Television 430 displays the rating in the display area based on the output from display driver 428.

CPU 410 keeps time elapsed since the start of display of the rating on display 430, and when the time exceeds a time set in advance, CPU 410 causes OSD image generation circuit 424 to display a message urging an input indicating that the rating has been confirmed. When a viewer sees the message displayed on display 430 and inputs a manipulation instruction indicating that the rating has been confirmed, the input is received by light-receiving unit 406 and sent to CPU 410.

In step S732, CPU 410 senses the input indicating that the rating has been confirmed. In step S734, in response to the input, CPU 410 causes OSD image generation circuit 424 to generate a message urging end of communication via IP telephone with IP telephone management server 20.

In step S736, display 430 displays that message in the display area. Thereafter, CPU 410 waits for an external input.

In step S738, CPU 410 determines whether an instruction to end communication via IP telephone has been input or not. When CPU 410 determines that the instruction has been input (YES in step S738), control is switched to step S740. Otherwise (NO in step S738), control returns to step S736.

In step S740, CPU 410 disconnects the communication with IP telephone management server 20 by transmitting a frame to IP telephone management server 20 via communication I/F 470. When successful disconnection is sensed, in step S742, CPU 410 displays end of communication via IP telephone on display 430.

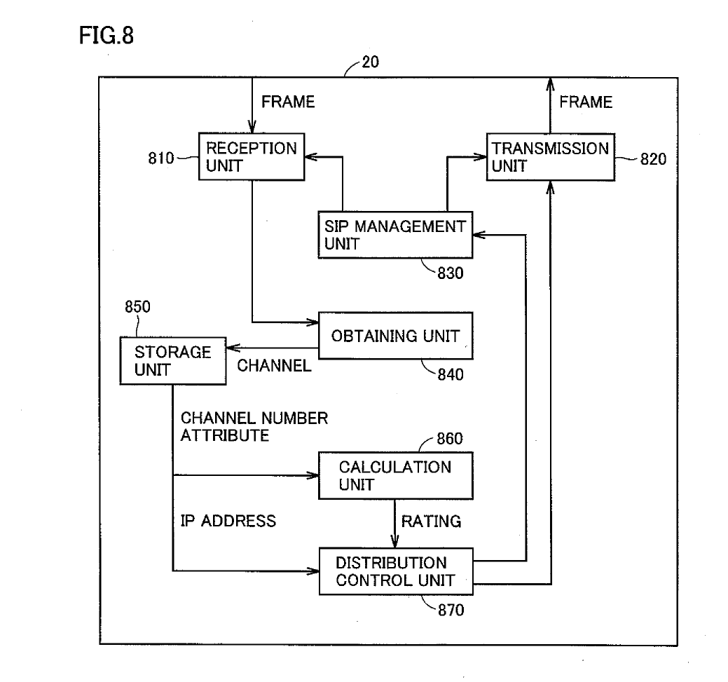

Referring next to FIG. 8, a configuration of IP telephone management server 20 according to the present embodiment will be described. FIG. 8 is a block diagram showing a function implemented by IP telephone management server 20. IP telephone management server 20 includes a reception unit 810, a transmission unit 820, an SIP management unit 830, an obtaining unit 840, a storage unit 850, a calculation unit 860, and a distribution control unit 870.

Reception unit 810 is connected to the Internet 30 and receives the frame transmitted to IP telephone management server 20.

Transmission unit 820 is connected to the Internet 30 and transmits the frame to a specific destination based on the IP address included in the frame to be transmitted.

SIP management unit 830 controls communication via IP telephone with another communication apparatus (such as television 40) connected to the Internet 30. Specifically, SIP management unit 830 controls transmission and reception of a signal to and from television 40, in accordance with a communication control protocol defined in advance. The communication control protocol defined in advance is, for example, an SIP.

Obtaining unit 840 obtains the position data and the channel data from the viewing information received by reception unit 810. The position data refers to data for specifying a position of television 40 in the Internet 30 (such as an IP address). The channel data corresponds to the channel number selected in television 40. Alternatively, in another aspect, obtaining unit 840 obtains attribute data input in advance for television 40 from the viewing information.

Storage unit 850 stores the data obtained by obtaining unit 840. Calculation unit 860 calculates each rating based on each piece of channel data stored in storage unit 850. Alternatively, if storage unit 850 stores also attribute data in another aspect, calculation unit 860 calculates the rating of each channel for each attribute defined by the attribute data.

Distribution control unit 870 transmits the rating calculated by calculation unit 860 to each television 40. Specifically, distribution control unit 870 reads the position data of each television 40 from storage unit 850, generates a frame containing a rating corresponding to the channel of each television 40 based on the position data, and sends the frame to transmission unit 820.

Transmission unit 820 sends the frame generated by distribution control unit 870 to a designated destination under control by SIP management unit 830.

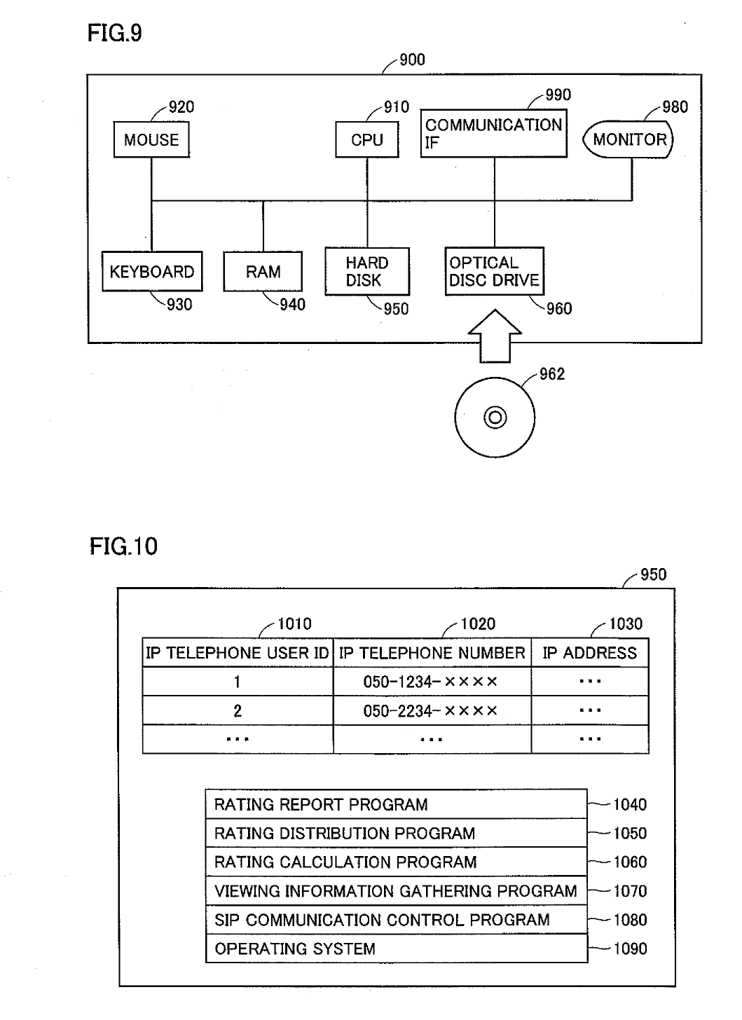

Referring next to FIG. 9, one manner of a specific configuration of IP telephone management server 20 will be described. FIG. 9 is a block diagram showing a hardware configuration of a computer system 900 that functions as IP telephone management server 20.

Computer system 900 includes, as main components, a CPU 910 executing a program, a mouse 920 and a keyboard 930 accepting input of an instruction by the user of computer system 900, a RAM (Random Access Memory) 940 temporarily storing data generated as a result of execution of a program by CPU 910 or data input via mouse 920 or keyboard 930, a hard disk 950 storing data in a non-volatile manner, a CD-ROM (Compact Disc-Read Only Memory) drive 960, a monitor 980, and a communication I/F 990. Hardware is connected to each other via a data bus. A CD-ROM 962 can be mounted on CD-ROM drive 960.

The processing in computer system 900 is implemented by each piece of hardware and software executed by CPU 910. Such software may be stored in hard disk 950 in advance. Alternatively, software may be stored in CD-ROM 962 or other storage media and distributed as a program product. Alternatively, software may be provided as a program product that can be downloaded by an information provider connected to what is called the Internet. Such software is read from the storage medium by CD-ROM drive 960 or other reading devices, or downloaded through communication I/F 990, and thereafter once stored in hard disk 950. The software is read from hard disk 950 by CPU 910 and stored in RAM 940 in the form of an executable program. CPU 910 executes that program.

Each configuration of computer system 900 shown in FIG. 9 is general. Therefore, it can be said that the most essential part relating to IP telephone management server 20 according to the present embodiment is software stored in RAM 940, hard disk 950, CD-ROM 962, or other storage media, or software that can be downloaded via a network. As the operation of each piece of hardware of computer system 900 is well-known, detailed description will not be repeated.

Referring next to FIG. 10, a data structure of IP telephone management server 20 will be described. FIG. 10 is a conceptual diagram showing one manner of storage of data in hard disk 950 of computer system 900. Hard disk 950 includes a plurality of areas for storing data.

Data for specifying a user capable of communication via IP telephone is stored in an area 1010. A telephone number assigned to the user is stored in an area 1020. An IP address of the user is stored in an area 1030. These types of data are stored in hard disk 950 after each user (that is, the user of television 40) agrees to receive IP telephone service and necessary setting is completed.

An operating system controlling a basic operation in computer system 900 is stored in an area 1090. An SIP communication control program for controlling communication between television 40 and IP telephone management server 20 in accordance with SIP is stored in an area 1080. A program executed so that IP telephone management server 20 gathers viewing information from each television 40 is stored in an area 1070. A program for calculating a rating is stored in an area 1060. A program for distributing the rating to corresponding television 40 is stored in an area 1050. In addition, a program for allowing report by IP telephone management server 20 to a sender of a broadcast signal received in each channel (television station) is stored in an area 1040.

CPU 910 sequentially executes each program stored in areas 1040 to 1090 to allow computer system 900 to function as IP telephone management server 20.

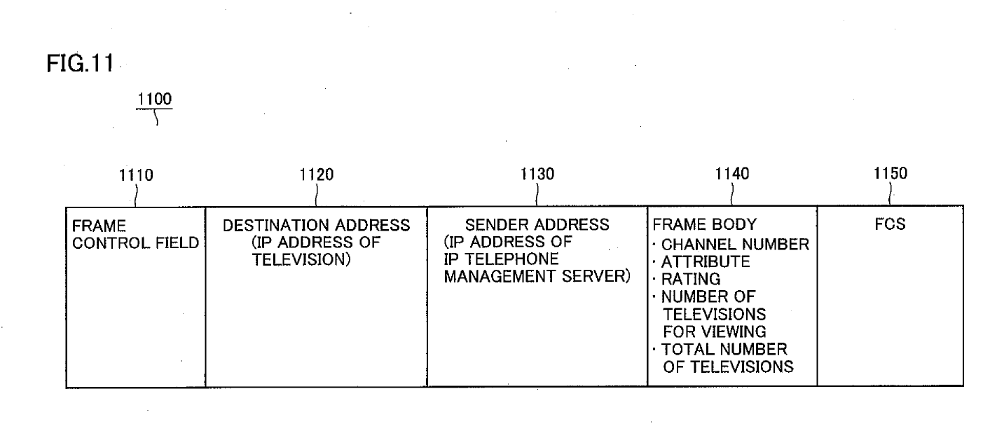

Referring next to FIG. 11, a rating transmitted from IP telephone management server 20 to each television 40 will be described. FIG. 11 is a conceptual diagram showing a configuration of a frame 1100 including the rating. A frame 1100 is distributed from IP telephone management server 20 to each television 40. Frame 1100 includes a frame control field 1110, a destination address 1120, a sender address 1130, a frame body 1140, and an FCS 1150.

Destination address 1120 includes an IP address of television 40 connected to the Internet 30. Sender address 1130 includes an IP address of IP telephone management server 20. Frame body 1140 includes a channel number, an attribute, a rating, the number of televisions for viewing, and the total number of televisions. The channel number refers to a number of a channel selected in television 40 to which frame 1100 is transmitted (namely, television 40 specified by destination address 1120). The attribute refers to an attribute defined for that television. The attribute includes, for example, a main user of the television, sex of the user, and the like. The rating refers to the rating calculated by CPU 910. The number of televisions for viewing refers to the number of all televisions where that channel is selected. The total number of televisions refers to the total number of televisions that have returned the viewing information to IP telephone management server 20 (namely, population).

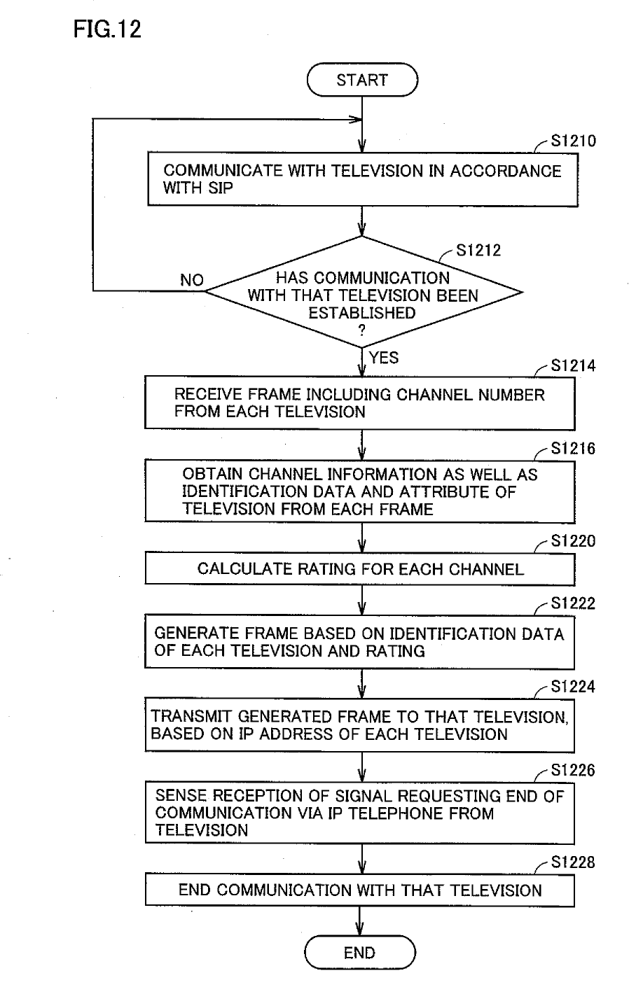

Referring next to FIG. 12, a control structure of IP telephone management server 20 will be described. FIG. 12 is a flowchart showing a part of processing performed by CPU 910.

In step S1210, CPU 910 communicates with television 40 via communication I/F 990 in accordance with the session initiation protocol. Negotiation for establishing communication via IP telephone is conducted between IP telephone management server 20 and television 40.

In step S1212, CPU 910 determines whether communication with television 40 has been established or not, based on a signal received via communication I/F 990. When CPU 910 determines that communication has been established (YES in step S1212), control is switched to step S1214. Otherwise (NO in step S1212), control returns to step S1210.

In step S1214, CPU 910 receives frame 600 including the channel number from each television 40 through the Internet 30. In step S1216, CPU 910 obtains the channel number as well as identification data and attribute data of television 40 from each frame 600 and stores the same in an area reserved in RAM 940.

In step S1220, CPU 910 calculates the rating for each channel. In step S1222, CPU 910 generates frame 1100 based on the identification data of each television 40 (such as area 1010) and the calculated rating. In step S1224, CPU 910 transmits generated frame 1100 to television 40 based on the IP address of each television 40 (area 1030). Receiving frame 1100, television 40 returns reception acknowledge ACK to IP telephone management server 20. In addition, television 40 emits a signal requesting end of communication with IP telephone management server 20.

In step S1226, CPU 910 senses reception of the request for ending communication via IP telephone from television 40. In step S1228, CPU 910 performs processing for ending communication with television 40 and ends communication via IP telephone.

As described above, according to the viewing information distribution system 10 of the present embodiment, each television 40 is connected to IP telephone management server 20 and establishes communication session via IP telephone. Each television 40 transmits to IP telephone management server 20, an operation state of the television at that time point, the selected channel, and the attribute information registered in television 40.

IP telephone management server 20 gathers the above-described attribute information transmitted from each television and calculates the rating for each attribute. The calculated rating is distributed to each television 40 in accordance with the attribute. Thus, the user of each television 40 can know in real time the rating of the program broadcast on the selected channel.

Therefore, each user can easily know a viewing state of each channel. In addition, the user can also know a particularly popular program in real time.

<First Variation>

A first variation of the present embodiment will be described hereinafter. A television according to the present variation is different from television 40 described previously in its ability to transmit the viewing information to IP telephone management server 20 for each user registered in advance as a user of that television.

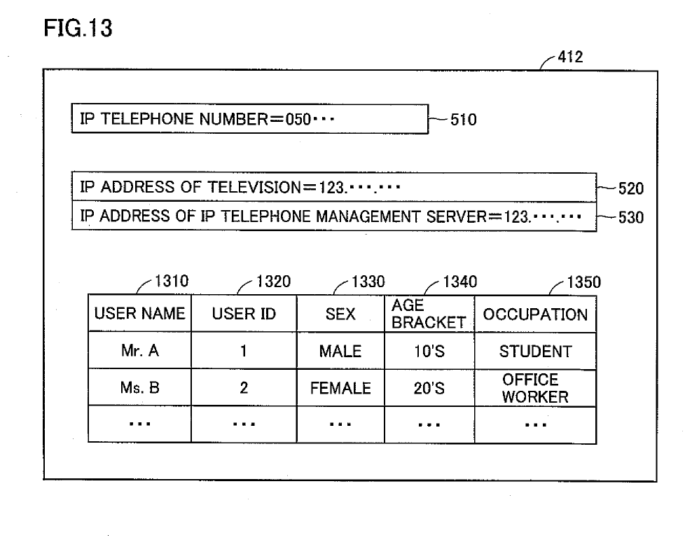

FIG. 13 illustrates one manner of storage of data in memory 412 of the television according to the present variation. In connection with the data structure of the television, memory 412 includes areas 1310 to 1350 for storing the attribute data for each user, in addition to areas 510 to 530 containing data for establishing communication via IP telephone. A user name for identifying the user of television 40 according to the present variation is stored in area 1310. As the user name is displayed on display 430, the user of television 40 can recognize the user name.

User ID (Identification) used for processing performed by CPU 410 is stored in area 1320. Data indicating sex of the user is stored in area 1330. Data indicating age bracket to which the user belongs is stored in area 1340. Data indicating occupation of the user is stored in area 1350. The user ID can be input by the television user's manipulation of a remote control device (not shown). A number of the user ID is obtained by CPU 410 in accordance with a rule defined in advance. Data stored in areas 1330 to 1350 are stored in these areas, based on the user's selection from among a plurality of pieces of data prepared in advance by the manufacturer of television 40.

Television 40 according to the present variation uses data stored in areas 1310 to 1350 so as to generate frame 600 to be transmitted to IP telephone management server 20. When television 40 generates frame 600, frame body 642 shown in FIG. 6 stores user name, user ID, sex, age bracket, and occupation as the attributes.

When frame 600 configured as such is transmitted from television 40 to IP telephone management server 20, IP telephone management server 20 calculates the rating of the channel in accordance with the attribute stored in frame body 640. As the rating is thus calculated for each attribute, other television users can readily know the rating of the channel selected by the user having the same attribute.

<Second Variation>

An IP telephone management server 1400 according to the present variation is different from IP telephone management server 20 described previously in attaining a function to distribute a request for transmitting viewing information to each television 40 to thereby calculate the rating.

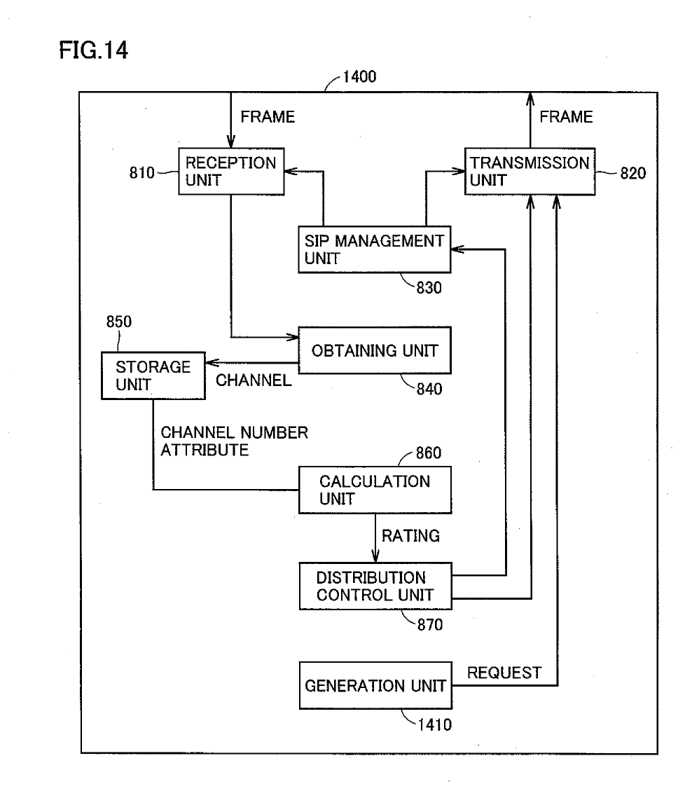

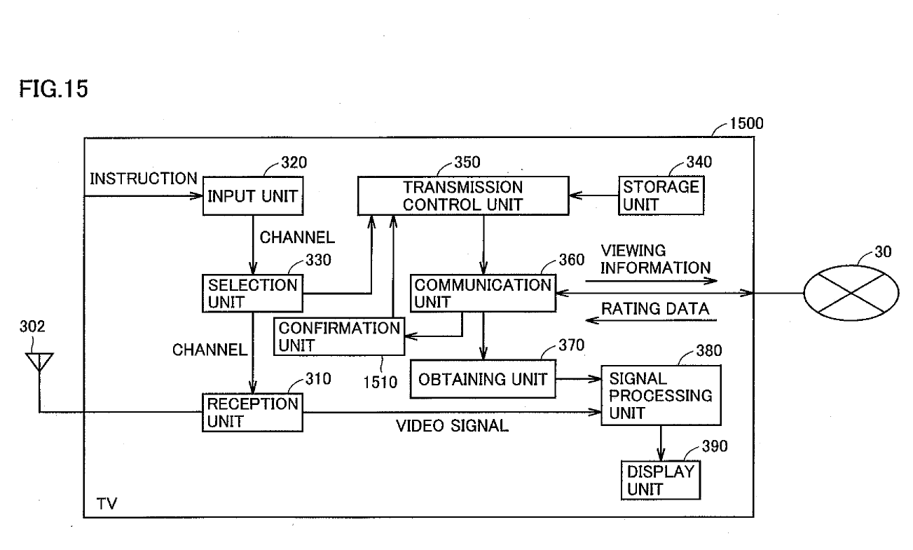

FIG. 14 is a block diagram showing a configuration of functions implemented by IP telephone management server 1400 according to the present variation. IP telephone management server 1400 further includes a generation unit 1410 in addition to the configuration shown in FIG. 8. Generation unit 1410 generates a signal requesting transmission of viewing information by each television 40. Preferably, generation unit 1410 generates the signal based on a manipulation instruction provided to IP telephone management server 1400.

Alternatively, in another aspect, generation unit 1410 generates the signal based on the fact that a time set in advance has come. Transmission unit 820 transmits a signal generated by generation unit 1410 to television 40 based on the session initiation protocol to which SIP management unit 830 is adapted. In a certain aspect, transmission unit 820 transmits the signal to specific television 40 based on a result of selection by distribution control unit 870. The result of selection may be based on random selection, for example, by using random numbers, or on a selection rule prepared in advance. According to IP telephone management server 1400, the viewing information in each television 40 can be obtained at timing requested by a manager of the server.

FIG. 15 is a block diagram showing a configuration of functions implemented by a television 1500 according to the present variation. Television 1500 further includes a confirmation unit 1510 in addition to the configuration shown in FIG. 3. Confirmation unit 1510 is connected to communication unit 360 and transmission control unit 350 so as to operate based on the output from communication unit 360. Confirmation unit 1510 confirms whether a request for transmitting viewing information has been received or not, based on the signal received by communication unit 360. Transmission control unit 350 controls transmission unit 360, so as to transmit the viewing information to IP telephone management server 1400 only when reception of that request has been confirmed. Thus, transmission of data contained in television 1500 to IP telephone management server 1400 before the viewer of television 1500 knows can be prevented.

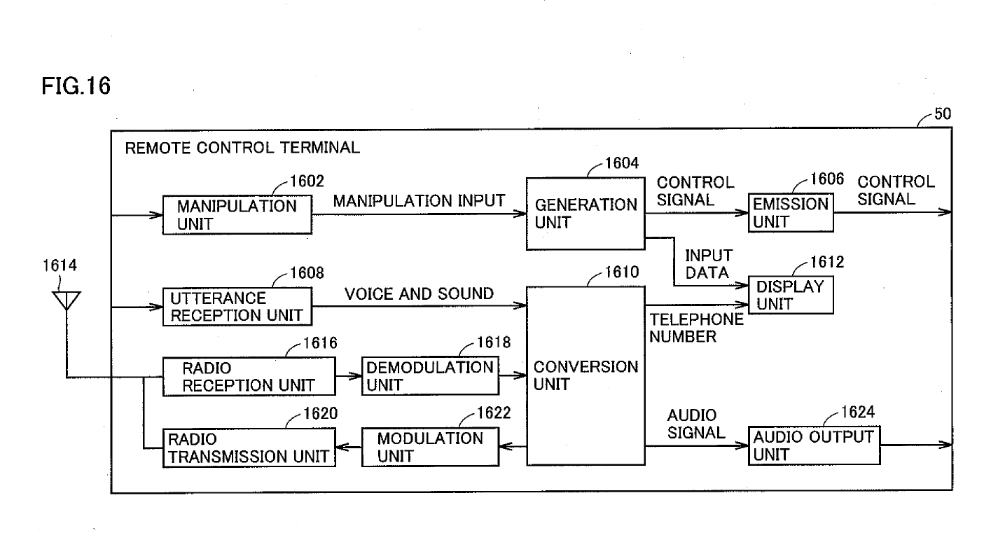

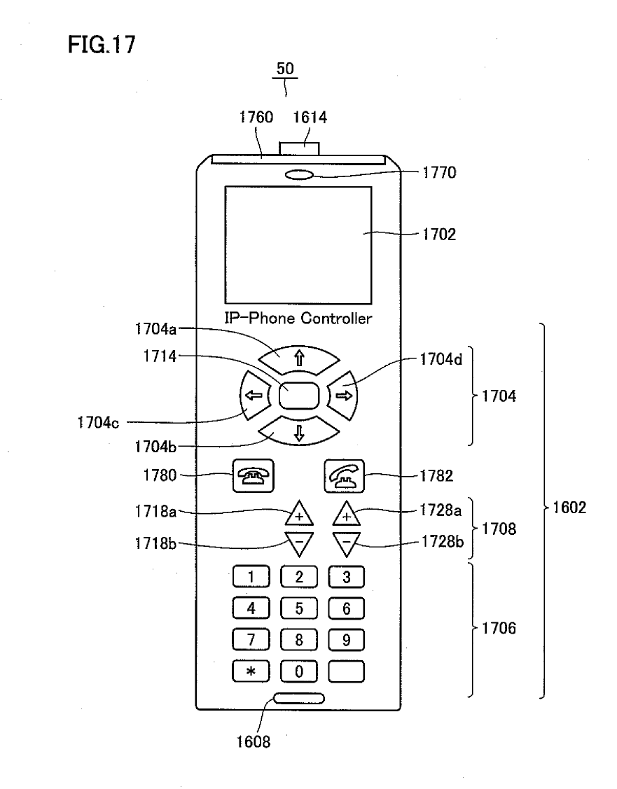

Referring now to FIGS. 16 and 17, a remote control terminal 50 for controlling each television above will be described. FIG. 16 is a block diagram showing a configuration of a main function of remote control terminal 50. Remote control terminal 50 attains a function to control equipment and an IP telephone function.

Remote control terminal 50 includes a manipulation unit 1602, a generation unit 1604, an emission unit 1606, an utterance receiver 1608, a conversion unit 1610, a display unit 1612, an antenna 1614, a radio reception unit 1616, a demodulation unit 1618, a radio transmission unit 1620, a modulation unit 1622, and an audio output unit 1624.

Manipulation unit 1602 accepts input of a manipulation instruction to remote control terminal 50. Manipulation unit 1602 sends a signal in accordance with the manipulation to generation unit 1604.

Generation unit 1604 generates a control signal for controlling an operation of television 40 based on the signal from manipulation unit 1602, and sends the generated signal to emission unit 1606.

Emission unit 1606 emits the control signal. For example, emission unit 1606 emits an infrared control signal.

Utterance receiver 1608 accepts voice and sound uttered by the user of remote control terminal 50. Utterance receiver 1608 sends the audio signal to conversion unit 1610.

Conversion unit 1610 processes the audio signal output from utterance receiver 1608 and converts the same into a signal format for radio transmission.

Display unit 1612 displays an image in accordance with the signal output from generation unit 1604 or an image in accordance with data output from conversion unit 1610. The displayed image includes a channel number for channel selection of television 40, a telephone number input for starting communication via IP telephone, and a telephone number of an originator of an incoming call.

Antenna 1614 receives a signal for IP telephone transmitted from television 40. Radio reception unit 1616 accepts input of a signal received by antenna 1614. Radio reception unit 1616 sends the signal to demodulation unit 1618.

Demodulation unit 1618 demodulates the signal and sends the demodulated signal to conversion unit 1610. Modulation unit 1622 modulates the signal output from conversion unit 1610 to generate a signal for radio transmission, and sends the generated signal to radio transmission unit 1620.

Radio transmission unit 1620 sends the signal to antenna 1614.

When the user of remote control terminal 50 utters toward utterance receiver 1608, the voice and sound is converted to a signal and thereafter emitted from antenna 1614. The emitted signal is received by an antenna 460 of television 40.

Alternatively, in another aspect, when remote control terminal 50 receives a signal for IP telephone emitted from television 40 via antenna 1614, conversion unit 1610 obtains a telephone number of an originator contained in the signal and sends the number to display unit 1612. Display unit 1612 displays the telephone number of the caller.

Moreover, conversion unit 1610 extracts the audio signal from the signal demodulated by demodulation unit 1618 and sends the signal to audio output unit 1624. Audio output unit 1624 outputs voice and sound based on the signal. For example, when remote control terminal 50 receives an IP telephone call, audio output unit 1624 outputs a ringing tone and voice and sound of the caller.

FIG. 17 shows appearance of remote control terminal 50. Remote control terminal 50 includes antenna 1614, manipulation unit 1602, a light-emitting unit 1760 configured to emit a control signal to controlled equipment as light, and a display 1702.

Specifically, manipulation unit 1602 is implemented by a button, a touch screen, a dial, or the like. Manipulation unit 1602 includes cursor buttons 1704a, 1704b, 1704c, 1704d configured to define up/down and left/right directions of a cursor displayed on display 1702, an enter button 1714 configured to accept input of an instruction to confirm entry made by the user of remote control terminal 50, an up/down button 1708 for incrementing or decrementing a value of a control signal to be output, and a numeric button 1706. Up/down button 1708 includes a first up button 1718a, a first down button 1718b, a second up button 1728a, and a second down button 1728b.

Remote control terminal 50 further includes a button 1782 configured to accept an instruction to receive or initiate an IP telephone call and a button 1780 configured to accept an instruction to end an IP telephone call.

As described above in detail, viewing information distribution system 10 according to the embodiment of the present invention gathers viewing information in each television, calculates a rating, and distributes the rating to each television. The rating is calculated in accordance with the attribute of the viewer. For example, the rating is calculated for each channel, each age bracket of the viewers, each sex, or each area where the television is installed. The timing of the calculation of the rating is determined also by the viewer of the television. Therefore, as each viewer can know the rating of the channel that is currently selected substantially in real time, zest for viewing is enhanced. An instruction to calculate the rating is sent from each television 40 to IP telephone management server 20 by manipulating remote control terminal 50 controlling the television. As the viewer should only manipulate remote control terminal 50, the rating can be obtained with simple manipulation.

In addition, the rating thus obtained can be fed back in real time to a broadcast station that broadcasts a program through the channel. Each broadcast station can obtain the rating from IP telephone management server 20 without configuring other schemes, so that feedback to production of a program is allowed.

Although the present invention has been described and illustrated in detail, it is clearly understood that the same is by way of illustration and example only and is not to be taken by way of limitation, the scope of the present invention being limited only by the terms of the appended claims.

What is claimed is:

1. A viewing information distribution system, comprising:
a plurality of television reception apparatuses; and
an information processing apparatus connected to said plurality of television reception apparatuses via a communication line;
each said television reception apparatus including
a communication unit configured to transmit or receive a signal to or from said information processing apparatus via said communication line in accordance with a communication protocol defined in advance,
an input unit configured to accept an instruction to select any channel from among a plurality of channels,
a selection unit configured to select said any channel based on said instruction,
a storage unit configured to store position data of each of said television reception apparatus and said information processing apparatus in said communication line, and
a transmission control unit configured to control said communication unit based on said position data of said information processing apparatus so that said position data of said television reception apparatus and channel data for identifying a channel selected by said selection unit are transmitted to said information processing apparatus,
said information processing apparatus including
a communication unit configured to transmit or receive a signal to or from each of said plurality of television reception apparatuses in accordance with said communication protocol defined in advance,
an obtaining unit configured to obtain said position data and said channel data from each piece of said viewing information received from each said television reception apparatus,
a storage unit configured to store obtained said position data and said channel data,
a calculation unit configured to calculate each rating of each said channel based on said channel data, and
a distribution control unit configured to control said communication unit so that calculated said rating is distributed to each said television reception apparatus for each channel selected in each said television reception apparatus, based on each piece of said position data, and
each said television reception apparatus including
an obtaining unit configured to obtain said rating from a signal received from said information processing apparatus, and
a display unit configured to display said rating obtained by said obtaining unit.

2. The system according to claim 1, wherein
each said communication unit in each said television reception apparatus and said information processing apparatus includes an Internet protocol telephone unit configured to transmit or receive a signal to or from said information processing apparatus via said communication line in accordance with Internet protocol.

3. The system according to claim 1, wherein
in each said television reception apparatus,
said transmission control unit generates packet data including said position data of said information processing apparatus, said position data of said television reception apparatus, and the channel data for identifying the channel selected by said selection unit, and
said communication unit transmits said packet data to said information processing apparatus based on said position data of said information processing apparatus.

4. The system according to claim 1, wherein
said information processing apparatus further includes
a generation unit configured to generate a request for transmitting said viewing information, and
a request unit configured to control said communication unit to transmit said request to all said television reception apparatuses,
each said television reception apparatus further includes a detection unit configured to detect said request from said information processing apparatus, and
said transmission control unit of said television reception apparatus controls said communication unit to transmit said viewing information based on detection of said request.

5. The system according to claim 1, wherein
said information processing apparatus further includes
a generation unit configured to generate a request for transmitting said viewing information,
a selection unit configured to select a television reception apparatus to which said request is to be transmitted, from among said plurality of television reception apparatuses, and
a request unit configured to control said communication unit to transmit said request to selected said television reception apparatus,
each said television reception apparatus further includes a confirmation unit configured to confirm whether said request has been received, based on a signal received from said information processing apparatus, and
when said confirmation unit confirms reception of said request, said transmission control unit of said television reception apparatus controls said communication unit to transmit said viewing information to said information processing apparatus.

6. The system according to claim 5, wherein
in said information processing apparatus,
said storage unit further stores identification data for identifying each said television reception apparatus, and
said selection unit generates random numbers and randomly selects each piece of said identification data based on said random numbers.

7. The system according to claim 1, wherein
in each said television reception apparatus,
said storage unit further stores an attribute of said television reception apparatus,
said generation unit generates said viewing information based on said channel data, said position data, and said attribute, and
in said information processing apparatus,
said obtaining unit further obtains said attribute from said viewing information, and
said calculation unit selectively calculates each rating of each said channel for an identical attribute, based on said attribute and said channel data.

8. The system according to claim 7, wherein
said attribute of said television reception apparatus includes an area where said television reception apparatus is installed.

9. The system according to claim 1, wherein
said information processing apparatus further includes a time keeping unit configured to keep time elapsed since transmission of said request, and
said calculation unit calculates said rating based on said viewing information received by said communication unit within a time period set in advance.

10. A television reception apparatus capable of communicating with an information processing apparatus connected to a communication line, said information processing apparatus communicating with each of a plurality of said television reception apparatuses in accordance with a communication protocol defined in advance, comprising:
a communication unit configured to transmit or receive a signal to or from said information processing apparatus via said communication line in accordance with said communication protocol defined in advance;
an input unit configured to accept an instruction to select any channel from among a plurality of channels;
a selection unit configured to select said any channel based on said instruction;
a storage unit configured to store position data of each of said television reception apparatus and said information processing apparatus in said communication line; and
a transmission control unit configured to control said communication unit based on said position data of said information processing apparatus so that said position data of said television reception apparatus and channel data for identifying a channel selected by said selection unit are transmitted to said information processing apparatus;
said information processing apparatus obtaining said position data and said channel data from said viewing information received from said plurality of television reception apparatuses, storing obtained said position data and said channel data, calculating each rating of each said channel based on said channel data, and distributing calculated said rating to each said television reception apparatus for each channel selected in said television reception apparatus, based on said position data; and
said television reception apparatus comprising:
an obtaining unit configured to obtain said rating from a signal received from said information processing apparatus; and
a display unit configured to display said rating obtained by said obtaining unit.

11. The television reception apparatus according to claim 10, wherein
said communication unit includes an Internet protocol telephone unit configured to transmit or receive a signal to or from said information processing apparatus via said communication line in accordance with Internet protocol.

12. The television reception apparatus according to claim 10, wherein
said transmission control unit generates packet data including said position data of said information processing apparatus, said position data of said television reception apparatus, and the channel data for identifying the channel selected by said selection unit, and
said communication unit transmits said packet data to said information processing apparatus based on said position data of said information processing apparatus.

13. The television reception apparatus according to claim 10, wherein
said information processing apparatus generates a request for transmitting said viewing information and transmits said request to all said television reception apparatuses connected to said communication line,
each said television reception apparatus further comprises a detection unit configured to detect said request from said information processing apparatus, and
said transmission control unit controls said communication unit to transmit said viewing information based on detection of said request.

14. The television reception apparatus according to claim 10, wherein
said information processing apparatus generates a request for transmitting said viewing information, selects a television reception apparatus to which said request is to be transmitted, from among said plurality of television reception apparatuses connected to said communication line, and transmits said request to selected said television reception apparatus,
each said television reception apparatus further includes a confirmation unit configured to confirm whether said request has been received, based on a signal received from said information processing apparatus, and
when said confirmation unit confirms reception of said request, said transmission control unit controls said communication unit to transmit said viewing information to said information processing apparatus.

15. The television reception apparatus according to claim 10, wherein
said storage unit further stores an attribute of said television reception apparatus, and
said generation unit generates said viewing information based on said channel data, said position data, and said attribute.

16. The television reception apparatus according to claim 15, wherein
said attribute of said television reception apparatus includes an area where said television reception apparatus is installed.

17. An information processing apparatus communicating with a plurality of television reception apparatuses connected to a communication line, each said television reception apparatus transmitting to said information processing apparatus, position data representing a position of said television reception apparatus in said communication line and channel data for identifying a selected channel in accordance with a communication protocol defined in advance, comprising:
a communication unit configured to transmit or receive a signal to or from each of said plurality of television reception apparatuses in accordance with said communication protocol defined in advance;
a storage unit configured to store said position data and said channel data received from each said television reception apparatus;
a calculation unit configured to calculate each rating of each said channel based on said channel data; and
a distribution control unit configured to control said communication unit so that calculated said rating is distributed to each said television reception apparatus for each channel selected in each said television reception apparatus, based on each piece of said position data.

18. The information processing apparatus according to claim 17, wherein
said communication unit includes an Internet protocol telephone unit configured to transmit or receive a signal to or from said information processing apparatus via said communication line in accordance with Internet protocol.

19. The information processing apparatus according to claim 17, further comprising:
a generation unit configured to generate a request for transmitting said viewing information; and
a request unit configured to control said communication unit to transmit said request to all said television reception apparatuses.

20. The information processing apparatus according to claim 17, further comprising:
a generation unit configured to generate a request for transmitting said viewing information,
a selection unit configured to select a television reception apparatus to which said request is to be transmitted, from among said plurality of television reception apparatuses; and
a request unit configured to control said communication unit to transmit said request to selected said television reception apparatus.

21. The information processing apparatus according to claim 20, wherein
said storage unit further stores identification data for identifying each said television reception apparatus, and
said selection unit generates random numbers and randomly selects each piece of said identification data based on said random numbers.

22. The information processing apparatus according to claim 17, wherein
each said television reception apparatus further stores an attribute of said television reception apparatus and generates said viewing information based on said channel data, said position data, and said attribute,
said obtaining unit further obtains said attribute from said viewing information, and
said calculation unit selectively calculates each rating of each said channel for an identical attribute, based on said attribute and said channel data.

23. The information processing apparatus according to claim 22, wherein
said attribute of said television reception apparatus includes an area where said television reception apparatus is installed.

24. The information processing apparatus according to claim 17, further comprising a time keeping unit configured to keep time elapsed since transmission of said request; wherein
said calculation unit calculates said rating based on said viewing information received by said communication unit within a time period set in advance.
